(19) United States
(12) Patent Application Publication
(10) Pub. No.: US 2025/0252605 A1
(43) Pub. Date: Aug. 7, 2025

(54) SYSTEMS AND METHODS FOR PERFORMING STAIN DECONVOLUTION

(71) Applicant: SUNNYBROOK RESEARCH INSTITUTE, TORONTO (CA)

(72) Inventors: JIANAN CHEN, TORONTO (CA); ANNE MARTEL, TORONTO (CA)

(21) Appl. No.: 18/856,153

(22) PCT Filed: Apr. 13, 2023
(86) PCT No.: PCT/CA2023/050507

§ 371 Date: Oct. 11, 2024

Related U.S. Application Data
(60) Provisional application No. 63/330,419, filed on Apr. 13, 2022.

(51) Int. Cl. G06T 7/90; G06N 3/0455; G06N 3/0464; G06N 3/08; G06T 11/00

(52) U.S. Cl. CPC G06T 7/90; G06N 3/0455; G06N 3/0464; G06N 3/08; G06T 11/001; G06T 2207/10024; G06T 2207/10056; G06T 2207/20081; G06T 2207/20084; G06T 2207/30024; G06T 2210/41

(57) ABSTRACT

Stain deconvolution methods and systems are disclosed employing a deep-image-prior-based neural network structure and associated training protocol. Example stain deconvolution networks employ auto-encoder networks to generate stain concentration maps for a plurality of stains associated with a colour target image, without requiring training based on a large reference image dataset. The stain deconvolution network is trained using a loss function that promotes correct image generation and the separation between the stain concentration maps generated by the auto-encoder networks. The deep-image-prior-based stain deconvolution networks may be configured to encode an adapted physics model that includes a set of parameters that model background illumination and the nonlinear dependence of absorption on concentration and wavelength. The present example methods of stain deconvolution, which may be performed in the absence of previous training data, are thus generalizable to accommodate multiple stains and previously uncharacterized stain types and can be extended to perform stain normalization.

### CROSS-REFERENCE TO RELATED APPLICATION

This application claims priority to U.S. Provisional Patent Application No. 63/330,419, titled “SYSTEMS AND METHODS FOR PERFORMING STAIN DECONVOLUTION” and filed on Apr. 13, 2023, the entire contents of which is incorporated herein by reference.

### BACKGROUND

The present disclosure relates to the deconvolution of stain components from color images, such as digital pathology tissue images.

Histopathology is a diagnostic discipline founded on the visual interpretation of cellular biology captured in images using stains that bind specifically to their target antigens. The advent of digitized images to pathology has propelled this traditional field into what is now described as digital pathology, where pathology information from stained slides is acquired, stored and managed to create large-scale datasets for disease diagnosis, biological research and drug development. Digital images lend themselves to computational pathology, both for basic measuring and counting and for advanced machine learning tasks. Images can now be evaluated by machine learning for features beyond the assessment of traditional histopathology, such as to directly link images to clinical data (e.g., prognosis, mutations).

Performing stain deconvolution from multi-stained images is thus an essential step in most of histology image analysis algorithms. Stain deconvolution is the process of transforming a stained tissue section image from the normal RGB colour space into a series of stain channels. Each stain channel is a grayscale image, which represents the intensity of a particular stain expression across the original image. Stain deconvolution methods typically attempt to find an ideal stain matrix, a matrix that when multiplied to the RGB colour channels produces the desired stain channels. A stain matrix is composed of stain vectors (also known as “colour vectors” or “stain colour vectors”), each with each stain vector representing the model colour of a particular stain from the original image and providing a correspondence between the contribution of a particular stain, for each colour channel, to the absorbance (optical density).

One common problem in analysis of tissue samples is an undesirable variation in color due to differences in color responses of slide scanners, raw materials and manufacturing techniques of stain vendors, and staining protocols across different pathology labs. This creates difficulty in image interpretation by software trained on a particular stain appearance, and further adds to already existing inter- and intra-expert variance in diagnosis and labeling among pathologists. This variation can be corrected for by performing stain deconvolution and then recombining the stain channels using a reference template. This is known as stain normalization.

### SUMMARY

Stain deconvolution methods and systems are disclosed employing a deep-image-prior-based neural network structure and associated training protocol. Example stain deconvolution networks employ auto-encoder networks to generate stain concentration maps for a plurality of stains associated with a colour target image, without requiring training based on a large reference image dataset. The stain deconvolution network is trained using a loss function that promotes correct image generation and the separation between the stain concentration maps generated by the auto-encoder networks. The deep-image-prior-based stain deconvolution networks may be configured to encode an adapted physics model that includes a set of parameters that model background illumination and the nonlinear dependence of absorption on concentration and wavelength. The present example methods of stain deconvolution, which may be performed in the absence of previous training data, are thus generalizable to accommodate multiple stains and previously uncharacterized stain types.

Accordingly, in a first aspect, there is provided a method of performing stain deconvolution on a colour target image, the method comprising:
providing a stain deconvolution network comprising:
   a plurality of convolutional auto-encoder neural networks, each convolutional auto-encoder neural network being configured to process a respective input dataset to generate a respective output dataset, each input dataset comprising a respective two-dimensional array having dimensions equal to the pixel dimensions of the colour target image;
   an absorbance calculation module configured to employ an absorbance model to generate a colour absorbance image, the colour absorbance image being generated by processing a plurality of stain vectors and a plurality of stain concentration maps, wherein each stain vector and each stain concentration map is associated with a respective stain;
   the absorbance calculation module being operatively coupled to the plurality of convolutional auto-encoder neural networks, such that each stain concentration map is obtained from the output dataset of a respective convolutional auto-encoder neural network; and
training the stain deconvolution network according to a stain deconvolution loss function comprising: a first loss component configured to minimize generation loss associated with the colour target image; and a second loss component configured to facilitate separation between the stain concentration maps; such that after the training, the stain concentration maps respectively represent deconvoluted stain concentration maps of the stains within the colour target image.

In some implementations of the method, the absorbance calculation module is further configured such that the colour absorbance image is generated by calculating a sum, over each stain, of the product the stain vector, the stain concentration map, and a stain spectral correction factor; wherein each stain has an associated stain spectral correction factor; and wherein each stain spectral correction factor is updated during the training, according to minimization of the stain deconvolution loss function.

The stain spectral correction factors may be defined according to stain spectral correction factor parameters of the stain deconvolution network, and wherein the stain spectral correction factor parameters are initialized prior to the training.

The stain deconvolution network may include a plurality of spectral correction neural networks, each spectral correction neural network being configured to determine a respective stain spectral correction factor, and wherein each spectral correction neural network is trained according to the stain deconvolution loss function. At least one spectral correction neural network of the stain deconvolution network may be an encoder-decoder network. The stain spectral correction factor corresponding to the at least one spectral correction neural network may be determined according to latent features of the at least one spectral correction neural network.

In some implementations of the method, the absorbance calculation module is further configured such that the calculation of the colour absorbance image includes a colour background vector; wherein the colour background vector is updated during the training, according to minimization of the stain deconvolution loss function. The colour background vector may be defined according to background parameters of the stain deconvolution network, and wherein the background parameters are initialized prior to the training. The stain deconvolution network may include a background neural network, the background neural network being configured to determine the colour background vector, and wherein the background neural network is trained according to the stain deconvolution loss function. The background neural network may be an encoder-decoder network. Values of the colour background vector may be determined according to latent features of the background neural network.

In some implementations of the method, the stain vectors are updated during the training, according to minimization of the stain deconvolution loss function. The stain vectors may be defined according to stain vector parameters stored within the stain deconvolution network, and wherein the stain vector parameters are initialized prior to the training. The stain deconvolution network may include a plurality of stain vector neural networks, each stain vector neural network being configured to determine a respective stain vector, and wherein each stain vector neural network is trained according to the stain deconvolution loss function. At least one stain vector neural network of the stain deconvolution network may be an encoder-decoder network. Values of the stain vector corresponding to at least one stain vector neural network may be determined according to latent features of the at least one stain vector neural network.

In some implementations of the method, during at least an initial portion of the training, the stain deconvolution loss function comprises an additional loss term based on a difference between the stain vectors calculated by the stain vector neural networks and pre-determined initialization values of the stain vectors. The additional loss term may be included in the stain deconvolution loss function during the initial portion of the training and is absent from the stain deconvolution loss function during a subsequent portion of the training.

In some implementations, the method further includes employing the stain vectors to perform normalization when processing a different colour target image.

In some implementations, the method further includes employing the colour absorbance image to generate an output image, thereby providing a regenerated version of the colour target image.

In some implementations of the method, the first loss component is based on a difference between the colour absorbance image and a target colour absorbance image generated from the colour target image.

In some implementations of the method, the first loss component is based on a difference between the colour target image and an output image generated based on the colour absorbance image.

In some implementations of the method, at least one input dataset is randomly generated.

In some implementations of the method, at least two of the input datasets are a common input dataset.

In some implementations of the method, at least one of convolutional auto-encoder neural network includes a skip connection.

In some implementations of the method, during at least an initial portion of the training, computation of the loss function is augmented using at least one transformation of the input datasets.

In some implementations of the method, the colour target image is a first colour tile of a main color image, and wherein the stain vectors obtained after training are final stain vectors, the method further comprising employing the final stain vectors when performing stain deconvolution of another colour tile of the main colour image. The final stain vectors may be employed to initialize stain vectors when performing stain deconvolution of the other colour tile of the main colour image.

In some implementations, the method further comprises employing the stain concentration maps to perform stain quantification.

In another aspect, there is provided a system for performing stain deconvolution on a colour target image, the system comprising:
control and processing circuitry comprising at least one processor and memory, said memory comprising instructions executable by said at least one processor for performing operations comprising:
   generating a stain deconvolution network comprising:
      a plurality of convolutional auto-encoder neural networks, each convolutional auto-encoder neural network being configured to process a respective input dataset to generate a respective output dataset, each input dataset comprising a respective two-dimensional array having dimensions equal to the pixel dimensions of the colour target image;
      an absorbance calculation module configured to employ an absorbance model to generate a colour absorbance image, the colour absorbance image being generated by processing a plurality of stain vectors and a plurality of stain concentration maps, wherein each stain vector and each stain concentration map is associated with a respective stain;
      the absorbance calculation module being operatively coupled to the plurality of convolutional auto-encoder neural networks, such that each stain concentration map is obtained from the output dataset of a respective convolutional auto-encoder neural network; and
   training the stain deconvolution network according to a stain deconvolution loss function comprising:
      a first loss component configured to minimize generation loss associated with the colour target image; and
      a second loss component configured to facilitate separation between the stain concentration maps;
   such that after the training, the stain concentration maps respectively represent deconvoluted stain concentration maps of the stains within the colour target image.

A further understanding of the functional and advantageous aspects of the disclosure can be realized by reference to the following detailed description and drawings.

### BRIEF DESCRIPTION OF THE DRAWINGS

Embodiments will now be described, by way of example only, with reference to the drawings, in which:

FIG. 1 schematically illustrates a conventional matrix-factorization-based stain color devolution method.

FIG. 2 schematically illustrates an example of a conventional deep-learning approach to stain normalization.

FIG. 3A illustrates an example embodiment of a stain deconvolution network that is based on the use of multiple deep image priors for the determination of stain concentration maps.

FIG. 3B illustrates an example implementation of suitable autoencoder network for use with the example stain deconvolution network of FIG. 3A.

FIG. 4 shows an example of a deep-image-prior-based stain deconvolution network in which the stain vectors are refined during training of the auto-encoder neural networks.

FIG. 5 schematically illustrates different example methods for refining the stain vectors during training of the deep-image-prior-based stain deconvolution network.

FIG. 6 illustrates an example embodiment in which the stain deconvolution network includes auto-encoder neural networks that are employed to generate stain concentration maps associated with two stains.

FIG. 7 illustrates an example method in which a deep-image-prior-based stain deconvolution network is employed to perform stain normalization.

FIG. 8 shows an example system for performing stain deconvolution.

FIG. 9 shows unsupervised clustering results of physical parameters estimated by the stain deconvolution network match the scanner types in an example dataset.

FIG. 10 illustrates how the stain spectral correction factor can reduce the systematic error in color deconvolution compared to traditional approaches.

FIG. 11 shows stain deconvolution results in three types of digital pathology images and an example of how spectral correction factor improves stain deconvolution performance.

FIG. 12 shows a comparison of the proposed approach with state-of-the-art stain deconvolution methods for color deconvolution of H&E images where the proposed approach achieved the highest point-biserial correlation.

FIG. 13 shows a comparison of the proposed approach with state-of-the-art stain deconvolution methods for color deconvolution of H&E images where the proposed approach achieved the best structural similarity index measure.

FIG. 14 shows an example of stain transformation and normalization on a dataset with images captured by 4 different types of scanners using the stain deconvolution network.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

Despite a significant interest in stain deconvolution methods, their generalizability to specific image analysis problems is often limited. Traditional stain deconvolution methods rely on matrix decomposition algorithms that are based on the Beer-Lambert Law, which relates the attenuation of non-scattering light to the properties of dyes used for staining.

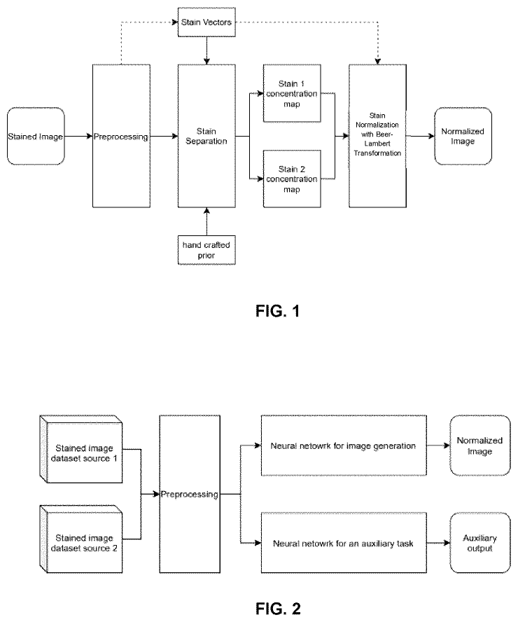

A conventional approach to stain deconvolution is illustrated in FIG. 1. A conventional approach casts the color devolution problem as a matrix factorization problem. After preprocessing steps such as resizing and background illumination correction, Beer-Lambert transformation is applied to convert the observed image intensity values in each RGB channel as optical densities, then stain concentration map and stain color vector for each stain are recovered using matrix factorization. To achieve better performance over baseline non-negative matrix factorization (NMF) or singular value decomposition (SVD), traditional physics-based methods rely on hand-created priors (e.g. sparsity, structure shape, criterions for histogram/spectral matching), yet these priors are laborious, heuristic and stain-specific. The color absorbing properties of dyes (stain vectors) are either pre-defined from empirical observations or estimated using template matching from hand-picked region of interests (ROI).

While most stain deconvolution methods remain relatively robust for hematoxylin and eosin (H&E) stained images, their application to specialized stains is severely impacted. Indeed, the stain deconvolution of other stains relies on problem-specific designs, which requires extensive domain expertise and experience to develop for one set of stains, and rarely translate to other sets of stains.

Specifically, the assumptions of the Beer-Lambert Law typically break down in practice for stain deconvolution based on stains other than H&E, often leading to significant deconvolution errors. Furthermore, with the rapid development of digital pathology, special stains are gaining increasing popularity for revealing detailed information and structures that improves disease diagnosis and treatment beyond what traditional H&E stains can offer.

The recent success in deep learning has shifted the focus of stain deconvolution methods to neural network-based approaches and shed light to stain deconvolution of special stains. FIG. 2 illustrates an example of a conventional deep-learning approach to stain normalization. Deep-learning approaches usually do not explicitly calculate concentration maps and stain vectors, but directly perform image-to-image translation (translating images with one stain type/source to another type/source). To achieve this, large datasets of images from two sources are required. Similar to the conventional physic-based approaches, images are first preprocessed then fed into two neural networks, leveraging the strong learning capacity of neural networks to learn color transformation and imaging structure at the same time. Apart from an image generation branch (GAN, VAE, etc.) for image reconstruction or image-to-image translation, deep-learning-based approaches usually incorporate an auxiliary branch for performance gain from solving another relevant task (e.g. tissue type clustering). Compared to traditional methods, deep-learning-based methods in general have better performance because their color separation/style transfer do not rely on hand-crated priors and manually selected ROIs.

However, deep-learning-based techniques are much less interpretable, and the normalization procedure requires template images from the target domain. Although existing deep learning-based approaches are claimed to be unsupervised as they do not require separated stain layer annotations, they rely on large, curated image datasets from different domains, and are therefore semi-supervised/weakly-supervised.

Moreover, while the strong capacity of deep learning enables stain deconvolution methods to bypass the limitations of the Beer-Lambert Law, their accessibility and generalizability are usually problematic. Existing deep learning-based approaches, despite being termed as “unsupervised” because they do not need ground truth for separated stain layers for training, require large, manually selected datasets, careful curation of the data, and high-level expertise in network design and training. The data-driven nature of existing deep learning-based stain deconvolution methods, on the one hand, makes them extremely powerful on the data they've been trained on, but on the other hand deteriorates their performance on unseen data. The lack of a generally applicable stain deconvolution algorithm is a hurdle for the development of digital pathology analysis.

The present inventors realized that the limitations of conventional deep learning methods for stain deconvolution could be avoided by employing a deep learning framework that does not require pre-training based on large image datasets. Indeed, by employing a deep-image-prior-based deep learning framework, accurate stain deconvolution could be performed using only the image data itself to train a network instead of relying on a large training dataset.

A deep image prior (DIP) neural network was first proposed for image inverse problems such as denoising and inpainting, based on the concept that the structure of a neural network, in particular, the convolutional filters, are capable of capturing the imaging statistics of natural images without being trained on a specific task. Deep image prior neural networks are trained to generate an output image, based on a loss function involving the target image, with random noise as input to the neural network, with randomly initialized network parameters. During the training process, the convolutional filters of the network capture the internal patch recurrence (also known as the image prior) and use this as basic building blocks to reconstruct the target image, so that external image information, such as noise or artifacts, can be removed, facilitating the restoration of a denoised or corrected version of the target image.

Deep-image-prior-based neural networks have also been implemented that include two deep image prior networks (e.g. the so-called “double-DIP” network), based on the observation that when multiple deep image prior neural networks are combined to reconstruct an image, each deep image prior neural network tends to split the image into meaningful decompositions, for example, background and foreground, haze and dehazed image or overlapping images with different level of transparency.

The present inventors realized that a multi-deep-image-prior neural network could be employed to perform stain deconvolution, with a set of auto-encoder networks being employed to generate stain concentration maps for a plurality of stains associated with a colour target image, without requiring training based on a large reference image dataset. Instead, the present inventors reasoned that a multi-deep-image-prior network could be trained using a loss function that employs (i) a loss component, based on the colour target image, that promotes correct image generation, and (ii) a loss component that promotes the separation between the stain concentration maps generated by the auto-encoder networks.

As will be described in detail below, unlike previous stain deconvolution methods, the present stain deconvolution methods that employ a deep image prior neural network structure and associated training protocol can be employed to perform stain deconvolution for images with an arbitrary number and arbitrary type of stains. The present deep-image-prior-based stain deconvolution networks may also be configured to encode an adapted physics model that includes a set of parameters describing properties of background illumination light, polychromatic dyes and sensors, therefore providing enhanced interpretability. Because test-time stain deconvolution is performed without requiring previous training data, the present methods are able to generalize to accommodate new and previously uncharacterized stain types, without risk of overfitting or without the need for ground truth labels. Furthermore, since the present example deep-image-prior-based methods do not require training on an image dataset, and instead only need to be trained based on the colour target image itself, the methods can be applied on an entry-level graphics processing card.

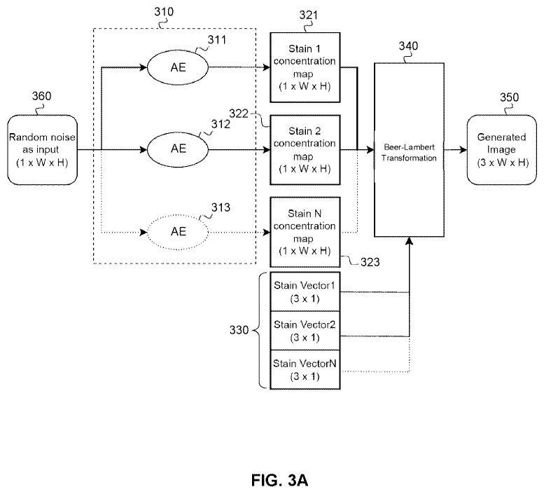

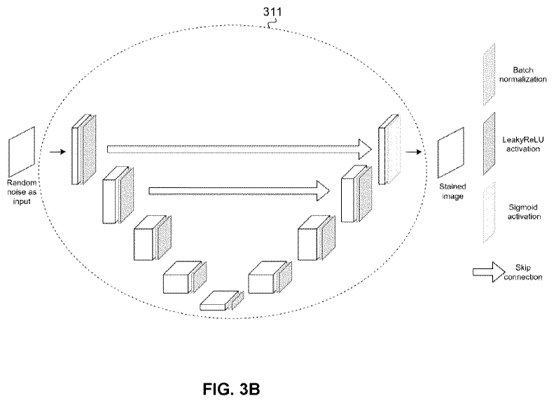

FIG. 3A illustrates an example embodiment of a stain deconvolution network that is based on the use of multiple deep image priors. The example stain deconvolution network does not require pre-training and is thus agnostic to stain type. A neural network portion 310 that contains multiple auto-encoder neural networks is employed to generate stain concentration maps for at least two stains, with the figure showing stain concentration maps 321 and 322 corresponding to a first stain and a second stain, and one or more optional additional stain concentration maps 323 corresponding to one or more optional additional stains.

As shown in the figure, the stain concentration maps 321-323 are processed in the absorbance calculation module 340, with corresponding stain vectors 330, to generate a colour absorbance image and/or a colour intensity image, as shown at 350. While a RGB color space is often employed in the examples provided in the present disclosure, it will be understood that other color spaces may be employed in the alternative, such as, but not limited to, HSV and LAB.

The deconvolution is performed on a colour target image that is a two-dimensional image having dimensions L×W and three colour channels, which can therefore be represented by a matrix having dimensions 3×L×W. Accordingly, each stain concentration map has dimensions of LxW, and each stain vector is a three-dimensional vector, with one dimension per colour channel.

In the present example method, the absorbance module employs the Beer-Lambert law to generate the colour absorbance image based on the calculated stain concentration maps 321-323. For example, in the case of a colour target image that corresponds to a sample having n mixed stains, the absorbance (optical density, OD) is generated from the stain vectors Cₖ and the stain concentration maps Sₖ, where k=1 . . . n represents the number of stains, as follows:

$$OD = {\sum }_{k = 1}^{n} {C}_{k} {S}_{k} ,$$

where the OD is a matrix having dimensions 3×L×W that represents the colour optical density of the colour target image (colour and pixel indices are not shown in the equation), and where each stain concentration map Sₖ is a matrix having dimensions L×W that represents the per-pixel concentration of a given stain (pixel indices are not shown in the equation), and where each stain vector cₖ is a 3-vector that relates the spectral optical density of a given stain to the concentration of the stain (where each dimension of the stain vector corresponds to a different colour channel).

As described in further detail below, this equation is but one example of an absorbance calculation, and other embodiments below disclose alternative absorbance calculation methods that include additional coefficients and/or terms.

The absorbance (OD) is related to the intensity image by the equation:

$$OD = {log}_{10} ( \frac{I}{{I}_{0}} ) ,$$

where I is the measured transmitted intensity through the sample and I₀ is the incident intensity on the sample. This equation can be inverted to generate a final colour image from a colour absorbance image.

In a conventional deep-learning-based workflow, the neural network would be trained based on a training image dataset to fix the activations and weights of the neural network. The target image would then be processed by the trained network. In stark contrast, however, the stain deconvolution network shown in FIG. 3A does not need to be trained based on a training dataset and the stain deconvolution network can determine the stain concentration maps 321-323 for the target colour image without the target colour image being provided as an input to the network. Instead, as described below, the stain concentration maps 321-323 can be determined based on a suitable loss function that involves the colour target image, using the concept of a deep image prior.

As shown in FIG. 3A, the neural network portion 310 includes, for each stain, a respective auto-encoder network 311-313, which are employed to generate the respective stain concentration maps 321-323. The auto-encoder networks 311-313 need not be trained prior to performing stain deconvolution on the colour target image.

A non-limiting example of a suitable auto-encoder network 311 is shown in FIG. 3B. In this example implementation, skip connections are included between the first layer of the encoder to the fifth layer of the decoder, and between the second layer of the encoder and the fourth layer of the decoder. It will be understood that the use of skip-connections, and the number of skip connections, are optional may vary among implementations of the present embodiment. Moreover, it will be understood that other hyperparameters are also variable according to different implementations, including, for example, the number of channels, number of layers, the type of activation.

Referring again to FIG. 3A, each auto-encoder network can be provided, as input, with a random noise dataset 360 (e.g. random uniform noise in the range of [−0.5, 0.5]), or any other dataset, including the colour target image itself. Although the figure shows each auto-encoder network being fed with the same input dataset, this is merely one implementation, and the auto-encoder networks may be fed with different input datasets in other example implementations.

While it may appear counterintuitive that a randomly initialized auto-encoder neural network can generate an accurate stain concentration map based on random input data that is not correlated with the colour target image in any way, the auto-encoder neural networks 311-313 of the example stain deconvolution network are capable of this function based on the use of a loss function that is based on the colour target image and which includes terms that enforce separation between the stain concentration maps.

The loss function for training the neural network portion 310 can include at least the following two loss components. The first loss component is a generation loss component employed to minimize generation error. This generation loss component may, for example, be configured to minimize the difference between the colour absorbance image that is generated based on the stain concentration maps according to the Beer-Lambert law (henceforth referred to as the “generated colour absorbance image”) and an absorbance image calculated from the colour target image, or, for example, to minimize the difference between a final image that is generated based on the stain concentration maps (e.g. using the equations shown above) and the colour target image. The generation loss may be a L1 type loss. For example, in some example implementations, the generation loss may be computed as L1-losses for the absorbance of each colour channel, and optionally include a loss term based on the sum of absorbance for the three colour channels.

The second loss term provides exclusion losses between the stain concentration maps to encourage separation between different stain layers, since different stains should be highlighting different regions of interest.

For example, in the case of a two-color stain separation problem (i.e. the colour target image includes contributions from two stains), the net loss function can include four generation losses (three per-colour channel absorption generation loss terms, one absorption sum (over all colour channels) generation loss term), and one exclusion loss term that facilitates separation between the two stain concentration maps. This example loss function can be generalized to N>3 colors by incorporating the aforementioned generation loss terms and N(N−1)/2 exclusion loss terms.

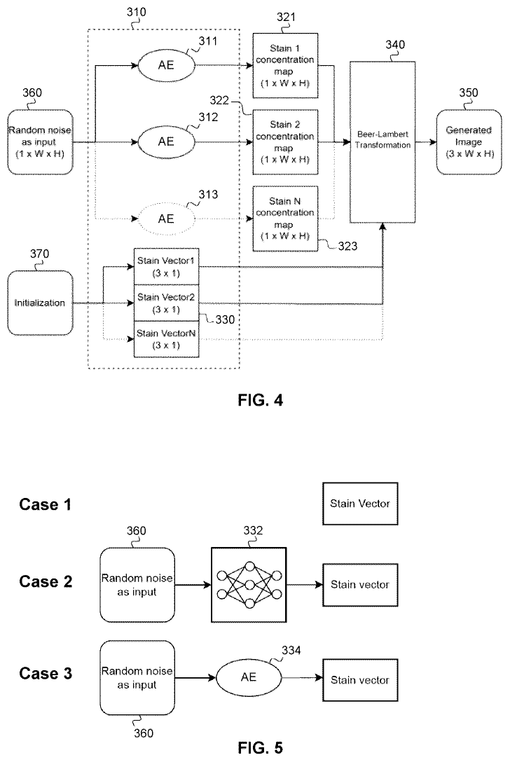

In some example embodiments, the stain vectors 330 are refined during training of the auto-encoder neural networks. For example, FIG. 4 illustrates an example embodiment in which the stain vectors 330 are shown residing with the neural network portion 310, indicating that their values are updated during training epochs of the auto-encoder neural networks. The staining vectors may be initialized, for example, from randomly initialized values, from user inputted stain vectors, or from stain vectors that could automatically be calculated from user-selected regions of interest in the input image as prior knowledge. In the latter case, the network will automatically adjust user-inputted stain vectors to achieve better separation results.

In one example implementation, the stain vectors 330 may be incorporated into the stain deconvolution network as parameters that are updated during training. For example, as shown in FIG. 4, the stain vectors 330 may be provided as a set of parameters (e.g. six parameters in the example case of two stains) that are stored and refined, during training, without a neural network structure. The values of the stain vector parameters are initialized by initial values (e.g. estimated values or random values) as shown at 370. This configuration is schematically also illustrated in case 1 of FIG. 5.

However, in other example implementations, each stain vector can be generated by respective a stain vector neural network structure that resides within the neural network portion 310 and is trained along with the auto-encoder networks that computer the stain concentration maps. Two example implementations of such an embodiment are illustrated in cases 2 and 3 of FIG. 5. Case 2 shows the example case in which a given stain vector is computed according to a feed-forward neural network 332, while case 3 illustrates the example case in which a given stain vector is computed according to an encoder-decoder network 334. In cases in which an encoder-decoder network 334 is employed to generate the stain vectors, the values of a given stain vector may be generated by, for example, a subset of pixels of a decoded image (including, for example, the central pixel of a decoded image), or, for example, based on latent features generated by the network.

In the case of example embodiments for which the stain vectors 330 are refined during training of the auto-encoder neural networks, the loss function may be adapted to include a loss component pertaining to the stain vectors. For example, a colour-fixing loss term may be included in the loss function to regulate the stain deconvolution network during at least a portion of the training.

In one example implementation, a L1 colour-fixing loss is computed between the estimated stain color vectors and initial values of the stain vectors in order to constrain the stain vectors during an initial portion of the training (for example, during an initial number of epochs, where the initial number of epochs lies below 2000), and is removed during the remaining portion of the training. This initial colour-fixing loss assists in making the network training more robust during initial training by focusing on learning the internal structure patterns before learning the stain vectors. In the example case of a colour target image relating to two stains, two colour-fixing loss terms may be included, one for each stain, which can be generalized to one colour-fixing loss term per stain.

In one example implementation, the colour fixing losses regulate the network in the first 25% epochs, and are removed in the last 75% epochs to allow the network to learn the stain vectors of the stains.

In some example implementations, augmentations may be provided during training of the neural network portion. Non-limiting examples of augmentations include 90-degree rotations and mirror operations performed on the input image data (e.g. random noise) to help the network learn a pose-invariant deep image prior. The augmentation may be included during an initial portion of the training (e.g. during the first 75% of the training epochs) and disabled during a latter portion of the training (e.g. during the last 25% epochs) to assist the network in focusing on deconvoluting the stains.

The present inventors also realized that the example stain deconvolution networks shown in FIGS. 3A and 4 could be further adapted to overcome limitations of conventional stain deconvolution methods.

Indeed, as described in detail in the Examples below, although widely used in almost all matrix decomposition-based approaches, the assumptions of Beer-Lambert law are always violated in practice. The Beer-Lambert law assumes monochromatic light (of a single wavelength), but background illumination light, stain absorption spectra, image sensor response, and color-matching observer functions are all wavelength dependent. Moreover, the Beer-Lambert law describes color absorbance, while some dyes are scatterers of light. Furthermore, existing methods of stain deconvolution suffer because the perceived color depends on spectral dependencies arising from light condition, room temperature, staining time, batch effects, and other factors that vary between images taken from the same scanner.

The assumption that stain vectors are independent of stain concentration therefore typically fails to hold due to the complex spectral responses of imaging cameras and light sources. Accordingly, stain deconvolution methods that are based on stain vectors without considering a dependence on stain concentration delivers less accurate concentration results.

The present inventors realized that a multi-deep-image-prior stain deconvolution network could be adapted to employ a modified form of the Beer-Lambert Law to address the systemic error that is caused by discrepancies between the nonlinear concentration dependence of stain vectors. Indeed, it was found that the problems associated with this nonlinearly could be addressed by introducing stain spectral correction factors that approximate the Beer-Lambert law (integral version of Beer-Lambert law) at individual image level, in contrast to dataset level which is used in all existing methods.

In some example embodiments, the Beer-Lambert Law is modified to include a stain spectral correction factor that assists in accommodating the aforementioned concentration dependence:

$$OD = {\sum }_{k = 1}^{n} {M}_{k} {C}_{k} {S}_{k} ,$$

where Mₖ is a per-stain scalar value.

The stain spectral correction factors approximately compensate for the nonlinearity from effects such as, but not limited to, the scattering of light, non-monochromatic light composition and non-monochromatic light reception of the camera. While the full non-linear relationship for each stain would be very challenging to calculate without extensive data, the present example methods approximate the non-linearity based on a per-stain scalar parameter that is assumed to be uniform across each image tile. The stain spectral correction factors are thus assumed to be fixed for one image tile, but may vary even between images from the same whole-slide image, and therefore cannot be calculated with any existing method.

The present methods that employ a deep-image-prior based network, however, may be readily adapted to determine the stain spectral correction factors during training. For example, the stain spectral correction factors Mₖ may be stored as parameters in network that are refined during training of the auto-encoder neural networks that generate the stain concentration maps. Alternatively, a feed-forward neural network, or an encoder-decoder network, trained according to the loss function, may be employed to generate the stain spectral correction factors (similar to the different implementations shown for the stain vectors, shown in FIG. 5.

While the present example embodiments employ a single parameter stain spectral correction factor for each stain, it will be understood that other example embodiments may employ, for each stain, multiple stain spectral correction parameters that include coefficients that define a nonlinear function of concentration. For example, such parameters may be determined by modeling the dependence of absorption of concentration as a function using a polynomial functional form.

Background illumination may affect the perceived color of images captured by a scanner and may vary significantly between different scanners. Existing methods rely on an extra preprocessing step based on a Gaussian denoising filter or sampling from background pixels to restore the pristine image. In order to achieve optimal performance with such existing methods, preprocessing steps, such as background illumination correction and denoising, should be performed prior to stain deconvolution. These procedures require histogram matching of manually selected background patches and hand-crafted noise-cancelling filters, which need to be designed for each domain (dataset/scanner), and can lead to biases.

In stark contrast, the preceding example embodiments of the present disclosure may be adapted to permit background illumination and noise to be automatically estimated and corrected without the need of human intervention. The presence and effect of background illumination can be addressed by including a background correction vector (a 3-element vector with one element per colour channel) that accounts for the change in optical density values in each channel:

$$OD = {\sum }_{k = 1}^{n} {M}_{k} {C}_{k} {S}_{k} + B .$$

The present methods that employ a deep-image-prior based network may be readily adapted to determine the background vector during training.

The background correction vector may be stored as parameters in network that are refined during training of the auto-encoder neural networks that generate the stain concentration maps. Alternatively, a feed-forward neural network, or an encoder-decoder network, trained according to the loss function, may be employed to generate the background correction vector (again, similar to the different implementations shown for the stain vectors, shown in FIG. 5).

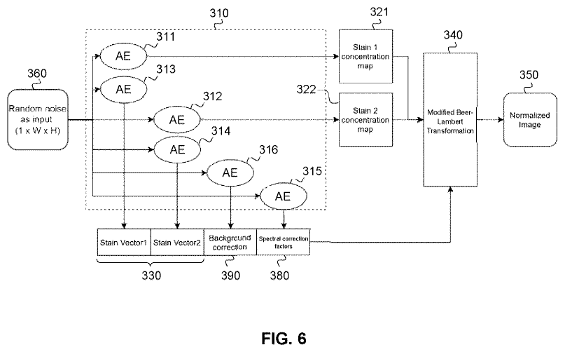

FIG. 6 illustrates an example embodiment in which the stain deconvolution network includes auto-encoder neural networks 311 and 312 that are trained, based on the colour target image data and a suitable loss function, to generate stain concentration maps 321 and 322 associated with two stains. As shown, the neural network portion 310 also includes auto-encoder neural networks 313 and 314 that are trained to determine the stain vectors 330. The network portion 310 also includes two optional additional auto-encoders 315 and 316, either of which may be optionally included and trained, according to the loss function, to generate the stain spectral correction factors 380 and/or the background correction vector 390. While the figure shows a single auto-encoder neural network 315 for generating the stain spectral correction factors 380, separate auto-encoder neural networks may be provided to compute each stain spectral correction factor. The network can be extended by adding the following additional modules for each additional stain: an additional concentration map auto-encoder, an additional stain vector auto-encoder (or parameter set or feed forward network), an additional stain spectral correction factor auto-encoder (or parameter set or feed forward network). Moreover, the stain deconvolution network may be expanded, for example, with the inclusion of additional modules that capture additional components, including, but not limited to ink marks, color temperature and white balance.

In some example embodiments, a deep-image-prior-based stain deconvolution network may be employed to perform stain normalization. Stain normalization refers to the use of a standard (or otherwise predetermined) set of stain vectors in conjunction with a given set of stain concentration maps in order to obtain an image, in order to reduce variations between images obtained using different scanners, thereby reducing the difficulty for down-stream analysis.

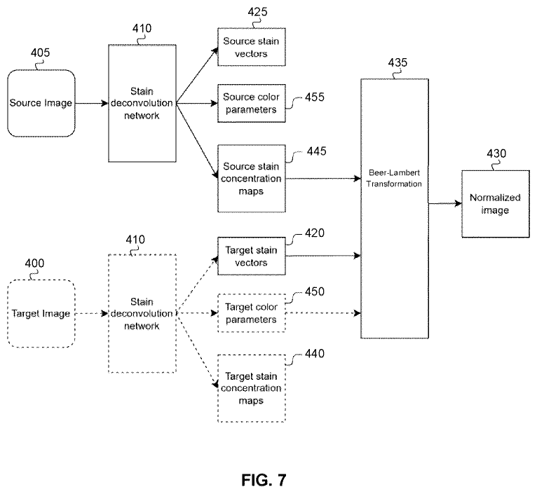

FIG. 7 schematically illustrates a method of employing target stain vectors 420, obtained by the processing of a colour target image 400 with a deep-image-prior-based stain deconvolution network 410, to generate a normalized reconstructed source image 430 from a source image 405 via the Beer-Lambert transformation 435 (or a modified form thereof). As shown in the lower portion of the figure, the stain deconvolution network 410 is trained, based on the target colour image 400, as per the present example embodiments involving the use of multiple deep image prior modules (auto-encoders). The training results in the calculation of the target stain vectors 420, as well as the target stain concentration maps 440, and the stain deconvolution network may be further configured to determine additional target colour parameters 450 associated with a physical model, such as target stain spectral correction factors and/or a target background vector.

As shown in the upper portion of FIG. 7, the stain deconvolution network 410 is also trained based on the source colour image 405, as per the present example embodiments involving the use of multiple deep image prior modules (auto-encoders). The training results in the calculation of the source stain vectors 425, as well as the target stain concentration maps 445, and, if the stain deconvolution network is so configured, additional source colour parameters 455, such as source stain spectral correction factors and/or a source background vector. To generate the normalized reconstructed source image 430, the physical model (e.g. a suitable form of the Beer-Lambert law) is employed to process the source stain concentration maps 445 and the optional additional source parameters 455 using the target stain vectors 420 instead of the source stain vectors 425.

FIG. 7 also illustrates an example case in which the target stain vectors 420 have already been determined, such that it is not necessary to perform training of the stain deconvolution network in the lower portion of the figure, with these unnecessary operations shown in dashed lines. In such a case, the target stain vectors 420 can be employed to replace the source stain vectors 425 when generating the normalized reconstructed source image 430.

In some example implementations, the aforementioned normalization methods, or variations thereof, may be employed for stain normalization of whole slide images. When images are scanned and/or processed in different laboratories, the appearance of the image often varies significantly. Pathologists become accustomed to a particular appearance and prefer images to be displayed with similar colour and intensity ranges. Also, many image analysis pipelines and Al models rely on consistent colours in order to work. In some example implementations, the stain vectors obtained after training based on one image tile may be employed to initialize the stain vectors that are employed when performing stain deconvolution of another tile of the image.

In some example embodiments, stain quantification may be performed on an image generated according to the present example stain deconvolution methods. For example, a set of stain concentration maps determined by a stain deconvolution network generated according to (or based on) embodiments disclosed herein may be employed to quantify a relative fraction of a given cell type. This may be performed, for example, by identifying and quantifying cells within individual stain concentration maps, and, for example, generating a ratiometric measure based on the cell counts. Alternatively, quantification may be performed based on pixels to identify stained vs. unstained tissue, which is adaptable to nuclear, cytoplasmic or membrane stains.

In one non-limiting example case, the present example methods may be employed to quantify p53 protein abundance in cancerous tissue. The tissue may be stained with a primary anti-p53 antibody, and a secondary antibody with peroxidase is employed to visualize a DAB chromogen, with counter-stain being performed with hematoxylin. The secondary antibody is linked to the peroxidase enzyme, which causes the DAB chromogen to produce a visible brown precipitate at the antigen (i.e. p53) site. Applying a stain deconvolution network according to the present example methods provides the stain concentration maps for DAB (p53) and hematoxylin (cell nucleus). In one example quantification method, in a region of interest, the presence of p53 can be quantified by the number of p53 positive cells that are stained with DAB divided by the total number of cells that are stained with hematoxylin and/or DAB. In another example implementation, quantification may be performed based on pixels within the stain concentration maps, as opposed to identified cells.

It will be understood that when performing stain quantification, one or more concentration maps may be thresholded to remove background pixels (e.g. low concentration pixels) in order to remove pixels are not expected to belong to cells. A pathologist/researcher may determine a suitable threshold to define the positive pixels, for example, by visual inspection.

It will be understood that there are many antigens for different applications, and that P53 is but one example of an antigen. Other examples of antigens include, for example, antigens that bind to ER and PR receptors in breast cancer, or antigens that highlight different kinds of inflammatory cells. The antigen determines the distribution of the stain, and the two common types of distribution are generated from nuclear and membrane stains. P53, ER and PR are all examples of nuclear stains. The chromatins, on the other hand, determine the colour. The choice of chromatins varies according to application and lab, but the DAB stain/hematoxylin counterstain is a common chromatic combination. As noted above, the present stain deconvolution embodiments, which do not require the presence of a training dataset, are suitable for processing both known and novel colour combinations.

As described in the Examples section below, the present inventors have found that the present deep-image-prior-based methods can outperform existing deep-learning-based approaches for stain deconvolution for various types of stains. Moreover, the present inventors have found that the present deep-image-prior-based methods are unique in that they are capable of deconvoluting any types of stains, without requiring task-specific empirical optimization.

Without intending to be limited by theory, it is believed that the strong generalizability of the present deep-image-prior based approach arises from the encoding of the physics model with the image-prior-based deep neural network, which complement and complete each other. Specifically, the deep neural network leverages the regulation of the physics model to achieve optimization solely based on the target image itself, which is non-precedent in deep-learning-based stain deconvolution. In particular, in the example embodiments in which the stain spectral correction factors are calculated via deep learning neural networks during training of the overall network, it is possible to broaden the application scope of the fundamental physics theory and reduce deconvolution error significantly.

The demonstrated strong performance of the present example embodiments demonstrates that it is possible to train a capable machine learning model at test-time based on the target image itself, which not only avoids the labor-intensive and time-consuming data collection and curation process, but also prevents overfitting. The synergy between physics model and deep-image-prior-based deep neural network also addresses another problem of neural networks-interpretability. The output of some example stain deconvolution networks of the present disclosure includes a set of physical parameters that explicitly describe conditions and properties involved in the whole process of light emission from dyes to scanner cameras. The results shown in the examples below suggest that the present example stain deconvolution networks that employ a modified Beer-Lambert physics model, with associated physical parameters, enables stain deconvolution networks to perform well on less commonly used stains, confirming the effectiveness of the modifications to the physics model.

It is further noted that in addition to stain deconvolution, the present deep-image-prior-based methods also automated and enable denoising of the image. Digital pathology images contain an extensive amount of noise and artifacts. While most noise appears insignificant to human perception, it is apparent in the “eyes” of compute classifiers. The implementation of a deep-image-prior-based network structure and training protocol facilitates this denoising capability. The auto-encoders that are employed and trained to generate stain concentration maps utilizes a limited amount of convolution filters to capture the internal patch recurrence of the colour target image. This network structure and training protocol enables the learning of the building blocks for the regular structures, but not the irregular noise and small artifacts. Moreover, as described above, in implementations that address and model the nonlinear dependence of stain vectors on concentration, and modeling the properties of the background light, these effects can be incorporated directly into the end-to-end training of color deconvolution, allowing for a more straightforward and convenient solution to an essential preprocessing step.

Indeed, the stain deconvolution method implemented using a deep image prior framework fully relies on the information supplied by the test image. It is noted that its performance could be deteriorated when the quality of the test image is low, especially when the proposed generalized assumptions—individual stains are uniform in the target image and the properties of stains are different—is violated. For example, when there is a high-concentration large ink-mark in the image, some implementations may tend to compute biased stain vector and concentration map as a compromise to fit both the stained structure and the ink-mark. Similarly, when the colors of two stains are too similar, some implementations may have suboptimal performance in assigning structures to the correct stains. However, it is noted that these aspects are not a result of the design of network structure itself, but are instead universal challenges for all stain deconvolution methods. In fact, the aforementioned example embodiments may be adapted to address these challenges by stacking additional deep-image-prior modules (auto-encoders), and updating the physics model (e.g. adding terms and/or parameters to the Beer-Lambert law) to take large artifacts into account, and by estimating all the intermediate physics parameters for better quality control.

It is therefore apparent that the present deep-image-prior-based methods may be beneficial providing a new generation of stain deconvolution methods that are generalizable across a wide variety of stains, while requiring neither expert knowledge nor previous data collection.

The present deep-image-prior-based stain deconvolution methods may find applications in a wide variety of settings, including, but not limited to, clinical pathology, pathology research, and pharmaceutical research. Indeed, pharmaceutical research laboratories make extensive use of immunohistochemistry to probe different biomarkers and to develop companion diagnostic tests. Such methods involve staining slides with several different dyes that label different antigens or markers. A very typical example is the use of hematoxylin to stain nuclei and a DAB stain bound to the antigen of interest. Methods of separating these stains are needed to provide more accurate quantitative results. In some research applications, there may be multiple different stain colours that are used to identify different structures in the tissue. Although some stain separation methods exist, they generally need to be adapted to each new assay. The present deep-image-prior-based stain deconvolution methods may be advantageous for such applications because stain deconvolution can be performed automatically, for multiple stains that can exceed two stains, without requiring training on prior images, and without ground truth labels, thereby removing the need for a skilled operator to spend significant time tuning an image processing algorithm.

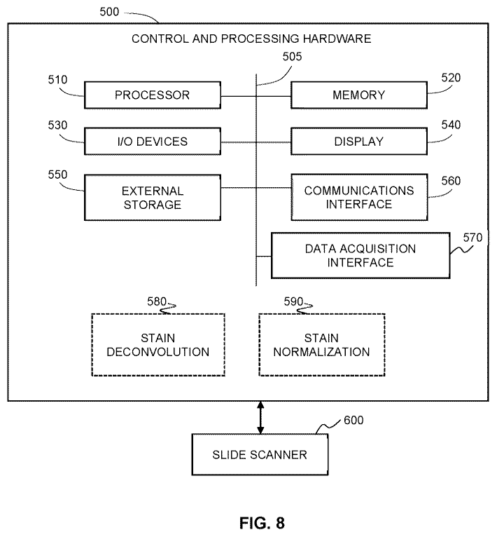

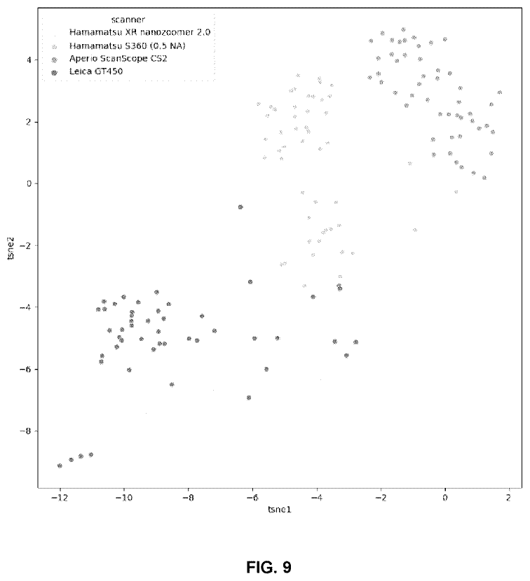

Referring now to FIG. 8, an example system is illustrated for performing stain deconvolution. Control and processing hardware 500 is employed to processing images received from a scanning device, such as a slide scanner 600 (e.g. a light source, a slide support, and an imaging camera), to perform stain deconvolution. As shown in FIG. 8, in one embodiment, control and processing hardware 500 may include a processor 510, a memory 520, a system bus 505, one or more input/output devices 530, and a plurality of optional additional devices such as communications interface 560, display 540, external storage 550, and data acquisition interface 570.

The present example methods of performing deep-image-prior-based stain convolution can be implemented via processor 510 and/or memory 520. As shown in FIG. 8, the process of training a stain deconvolution network, based on a colour target image and a suitable loss function, may be implemented by the control and processing hardware 500, via executable instructions represented as stain deconvolution module 580. Likewise, a stain normalization method may be implemented by the control and processing hardware 500 via executable instructions represented as stain normalization module 590.

The functionalities described herein can be partially implemented via hardware logic in processor 510 and partially using the instructions stored in memory 520. Some embodiments may be implemented using processor 510 without additional instructions stored in memory 520. Some embodiments are implemented using the instructions stored in memory 520 for execution by one or more general purpose microprocessors. In some example embodiments, customized processors, such as application specific integrated circuits (ASIC) or field programmable gate array (FPGA), may be employed. Thus, the disclosure is not limited to a specific configuration of hardware and/or software.

Referring again to FIG. 8, it is to be understood that the example system shown in the figure is not intended to be limited to the components that may be employed in a given implementation. For example, the system may include one or more additional processors. Furthermore, one or more components of control and processing hardware 500 may be provided as an external component that is interfaced to a processing device.

While some embodiments can be implemented in fully functioning computers and computer systems, various embodiments are capable of being distributed as a computing product in a variety of forms and are capable of being applied regardless of the particular type of machine or computer readable media used to actually effect the distribution.

At least some aspects disclosed herein can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

A computer readable storage medium can be used to store software and data which when executed by a data processing system causes the system to perform various methods. The executable software and data may be stored in various places including for example ROM, volatile RAM, nonvolatile memory and/or cache. Portions of this software and/or data may be stored in any one of these storage devices. As used herein, the phrases “computer readable material” and “computer readable storage medium” refers to all computer-readable media, except for a transitory propagating signal per se.

### EXAMPLES

The following examples are presented to enable those skilled in the art to understand and to practice embodiments of the present disclosure. They should not be considered as a limitation on the scope of the disclosure, but merely as being illustrative and representative thereof.

### Example 1: Example Implementation of Deep-Image-Prior-Based Stain Deconvolution Network

In some example implementations, each auto-encoder neural network of the stain deconvolution network may be implemented according to the design of U-Net, where a U-shaped architecture that consists of a downsampling encoder and a upsampling decoder is employed to generate the target image. As described above, in some example implementations, the input image is random noise and the convolutional filter size is 5×5. The encoder consisted of 5 convolutional layers each followed by Lanczos downsampling, batch normalization and LeakyReLU activation. The decoder consisted of 5 convolutional layers each followed by bilinear upsampling, batch normalization and LeakyReLU activation, with the exception of the final layer that is activated by Sigmoid activation. The scale factor for upsampling and downsampling was 2 and the input of each layer is padded accordingly. Moreover, the 4th and 5th layer of the encoder is skip-connected to the 2nd and 1st layer of the decoder, respectively.

The model was implemented on a consumer level Graphics processing unit (GPU), with most experiments performed in a GTX 1660 super GPU. It is believed that a prediction speed of a few seconds may be achieved on a data-center level GPU with optimized code.

The present example algorithm was employed to perform stain deconvolution on the MIDOG dataset (https://imi.thi.de/midog/the-challgenge/) with 200 high-power field images (˜7000×5000 pixels each), generated by imaging 50 breast cancer tissue samples using 4 different whole slide image scanners (Scanner 1: Hamamatsu XR nanozoomer 2.0; Scanner 2: Hamamatsu S360 (0.5 NA); Scanner 3: Aperio ScanScope CS2; Scanner 4: Leica GT450). A loci was randomly selected at the location of x=2000:2512, y=2000:2512 for every high power field image to create 200 512×512 cropped image tiles for evaluating the present example method. The physical parameters estimated for each image are visualized in a 2-dimenisonal space using t-SNE. The reduced representations of the physical parameters formed four clusters, clearly matching the scanner types used to image the samples.

The present example implementation of a deep-image-prior-based stain deconvolution method explicitly encodes a list of variables in its network structure to describe physical parameters involved in the light transmission from stained tissue samples to scanner cameras. When compared to traditional stain deconvolution methods that outputs stain concentration maps and stain vectors through a conventional deep-learning-based approach, the present example method outputs more variables that more clearly characterize the nonlinearity and the background illumination, thereby providing improved interpretability.

### Example 2: Theoretical Basis for Stain Spectral Corrections Factors

Based on the Bouguer-Lambert-Beer equation, the linear relation between the absorbance A and the concentration c is be defined as follows:

$$A ( λ ) = - ln ( \frac{I ( λ )}{{I}_{0} ( λ )} ) = {\sum }_{i} ( {δ}_{i} ( λ ) \cdot {c}_{i} ) , \qquad ( 1 )$$

where λ is wavelength, I is intensity, I₀ is maximum intensity, δ is molar optical density, representing the probability of light absorption for a sickness, and cᵢ is the concentration of the ith stain.

In practice, when stained images are captured by non-monochromatic devices, for example RGB colour cameras, equation 1 may lead to systemic errors due to the non-chromatic and therefore non-linear formation of light signals. To address the non-linearity, the absorbance values of red, green and blue spectral bands A_{R}, A_{G}, A_{B} can be modelled by:

$$\begin{matrix}{A}_{R} = - ln ( \frac{{\int }_{{λ}_{1}}^{{λ}_{2}} {I}_{0} ( λ ) \cdot {τ ( λ )}^{c} \cdot {s}_{R} ( λ ) \cdot d λ}{{\int }_{{λ}_{1}}^{{λ}_{2}} {I}_{0} ( λ ) \cdot {s}_{R} ( λ ) \cdot d λ} ) \\ {A}_{G} = - ln ( \frac{{\int }_{{λ}_{1}}^{{λ}_{2}} {I}_{0} ( λ ) \cdot {τ ( λ )}^{c} \cdot {s}_{G} ( λ ) \cdot d λ}{{\int }_{{λ}_{1}}^{{λ}_{2}} {I}_{0} ( λ ) \cdot {s}_{G} ( λ ) \cdot d λ} ) \\ {A}_{B} = - ln ( \frac{{\int }_{{λ}_{1}}^{{λ}_{2}} {I}_{0} ( λ ) \cdot {τ ( λ )}^{c} \cdot {s}_{B} ( λ ) \cdot d λ}{{\int }_{{λ}_{1}}^{{λ}_{2}} {I}_{0} ( λ ) \cdot {s}_{B} ( λ ) \cdot d λ} )\end{matrix} \qquad ( 2 )$$

where λ₁ and λ₂ are the lower bound and upper bound visible wavelength region, τ is spectral transmittance, s is spectral sensitivity function of the imaging device, and I₀(λ) is the spectral intensity distribution of the illumination. According to equation 2, the concentration c is no longer linearly correlated with absorbance A. The relationship between absorbance and concentration cannot be precisely calculated according to the above model because there are too many nonlinearities and it is almost impossible to precisely measure the parameters in the integrals, for example, the spectral sensitivity of the imaging device s for all visible wavelengths.

If it is assumed the device and the environment is fixed for the target image when the image is captured, the absorbance A can be written as a function of concentration c as:

$$A = {f}_{λ} ( c ) \qquad ( 3 )$$

Though the parameters of f_{λ} cannot be measured, it is consistent for pixels with the same concentration level. Therefore, it is possible to approximate f_{λ} by estimating the value of f_{λ} at certain concentration levels using the proposed stain deconvolution neural network. By modeling f_{λ} as a function of c using a polynomial, the systemic error from non-linearity can be reduced. In digital pathology image analysis, only few concentration levels are relevant for each stain, while the present experimental results show that the deconvolution result is greatly improved even if, for each type of stain, f_{λ} is approximated as a constant float number (i.e. a constant), which is referred to henceforth as a stain spectral correction factor.

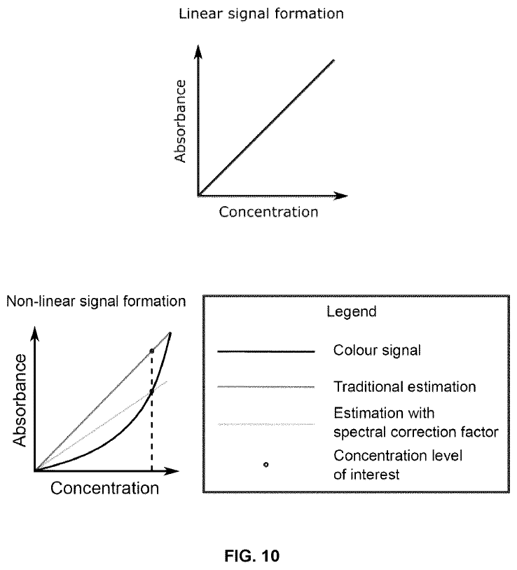

As shown in FIG. 10, estimating a nonlinear color signal with a linear model will lead to significant error (difference between the blue curve and the red curve). By introducing a spectral correction factor, the light absorbance model can be adapted to approximate the underlying non-linear signal formation. In the rightmost graph of FIG. 10, an example is given for how a float number (constant parameter) as the spectral correction factor can change the slope of the linear model to approximate the real absorbance value for the concentration level of interest (orange circle), for example, target nuclei for the stain.

### Example 3: Example of Stain Deconvolution Using an Implementation of Deep-Image-Prior-Based Stain Deconvolution Network

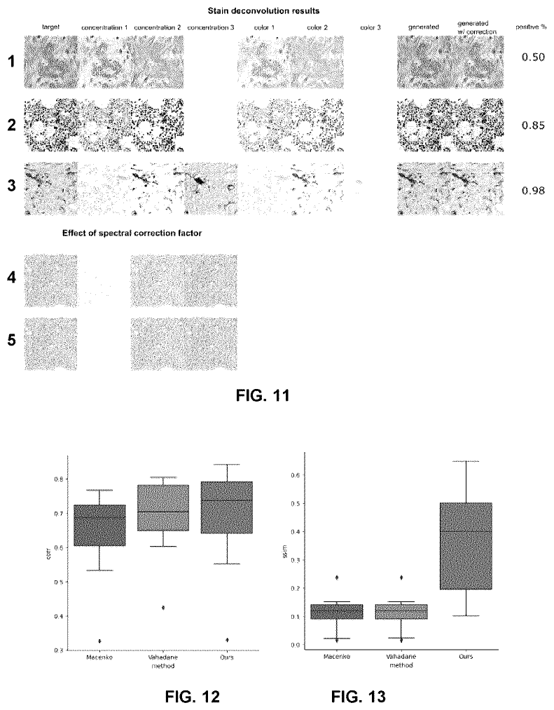

In this example, it is shown that the deconvolution results for images stained with three different combinations of dyes using the example implementation of the proposed algorithm from Example 1. Specifically, the model was tested with a hematoxylin and eosin (H&E) stained breast tissue image, hematoxylin and 3,3′-diaminobenzidine (DAB) stained bone marrow tissue image and a SMA CD34 MF3 antibody-stained breast tissue image, with results shown in rows 1, 2 and 3 of FIG. 11, respectively.

The present implementation of the proposed stain deconvolution network successfully deconvoluted all three types of stain combinations into concentration maps, color vectors and background correction vectors, as shown in FIG. 11. Combining all the deconvoluted components produces the generated image, which is compared with the target image for calculating the loss function during training. Combining all components except the background correction vectors leads to a background illumination corrected version of the target image. It is also possible to perform stain quantification by calculating the ratio of positively stained pixels over all pixels.

The performance of the implementation of the stain convolution network was also compared for a DAB-stained (DAB is scatterer of light) bone marrow tissue image with and without the spectral correction factor (row 4 and 5 of FIG. 11, respectively). Stain deconvolution with the spectral correction correctly estimated the color of the DAB dye to be brown (row 4), while the linear model (without the spectral correction factor) results in a clearly wrong pink color vector for DAB (row 5). This example shows that incorporating the spectral correction factor improves the performance of the stain deconvolution network for scatterers of light.

The stain deconvolution performance was also compared with two state-of-the-art traditional stain deconvolution algorithms: Macenko's algorithm and Vahadane's algorithm. The tissue sample was first stained with DAPI fluorescence imaging to obtain the gold standard of hematoxylin-sensitive tissue layer (concentration map). The sample was then washed and re-stained with Hematoxylin and Eosin (H&E). The DAPI images were registered to the corresponding H&E images and Otsu's thresholding was performed to get the ground truth. All three methods were applied to separate the stains and the resulting hematoxylin concentration maps were used for quantitative comparison. The results are shown in FIGS. 12 and 13. Two metrics were used for comparison: point-biserial correlation for measuring general correlation of high and low hematoxylin concentrations (between concentration maps and ground truth), and structural similarity. As can be seen in FIGS. 12 and 13, the present method is at least at the same level with the methods for comparison in terms of point-biserial correlation and is significantly better at preserving local structures compared to the other two methods.

### Example 4: Example of Stain Normalization Using an Implementation of Deep-Image-Prior-Based Stain Deconvolution Network

In this section, examples are provided of stain normalization using an implementation of the proposed stain deconvolution network. Stain normalization was performed using the same implementation as the one in Example 1 and on the same dataset: the MIDOG dataset (https://imi.thi.de/midog/the-challgenge/).

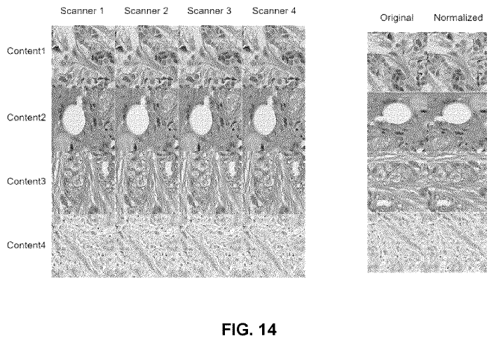

FIG. 14 illustrates example results of stain normalization using the proposed network. Four Image patches with different contents from four different scanners (Scanner 1: Hamamatsu XR nanozoomer 2.0; Scanner 2: Hamamatsu S360 (0.5 NA); Scanner 3: Aperio ScanScope CS2; Scanner 4: Leica GT450) were selected for stain normalization. The concentration maps and stain vectors for each image were calculated using the stain normalization network and mix-and-matched to generate all 16 possible combinations of styles and contents. For example, the first row shows the simulated appearance of content 1 scanned by the 4 scanners, and the second column shows the simulated appearance of all contents scanned by scanner 2. It is also possible to normalize the image patches scanned by different scanners with a pre-defined ‘standard’ color vector to make them look similar in style and therefore improve the performance of downstream analysis.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

1. A method of performing stain deconvolution on a colour target image, the method comprising:
providing a stain deconvolution network comprising:
a plurality of convolutional auto-encoder neural networks, each convolutional auto-encoder neural network being configured to process a respective input dataset to generate a respective output dataset, each input dataset comprising a respective two-dimensional array having dimensions equal to the pixel dimensions of the colour target image;
an absorbance calculation module configured to employ an absorbance model to generate a colour absorbance image, the colour absorbance image being generated by processing a plurality of stain vectors and a plurality of stain concentration maps, wherein each stain vector and each stain concentration map is associated with a respective stain;
the absorbance calculation module being operatively coupled to the plurality of convolutional auto-encoder neural networks, such that each stain concentration map is obtained from the output dataset of a respective convolutional auto-encoder neural network; and
training the stain deconvolution network according to a stain deconvolution loss function comprising:
a first loss component configured to minimize generation loss associated with the colour target image; and
a second loss component configured to facilitate separation between the stain concentration maps;
such that after the training, the stain concentration maps respectively represent deconvoluted stain concentration maps of the stains within the colour target image.

2. The method according to claim 1 wherein the absorbance calculation module is further configured such that the colour absorbance image is generated by calculating a sum, over each stain, of the product the stain vector, the stain concentration map, and a stain spectral correction factor;
wherein each stain has an associated stain spectral correction factor; and
wherein each stain spectral correction factor is updated during the training, according to minimization of the stain deconvolution loss function.

3. The method according to claim 2 wherein the stain spectral correction factors are defined according to stain spectral correction factor parameters of the stain deconvolution network, and wherein the stain spectral correction factor parameters are initialized prior to the training.

4. The method according to claim 2 wherein the stain deconvolution network comprises a plurality of spectral correction neural networks, each spectral correction neural network being configured to determine a respective stain spectral correction factor, and wherein each spectral correction neural network is trained according to the stain deconvolution loss function.

5. The method according to claim 4 wherein at least one spectral correction neural network of the stain deconvolution network is an encoder-decoder network.

6. The method according to claim 5 wherein the stain spectral correction factor corresponding to the at least one spectral correction neural network is determined according to latent features of the at least one spectral correction neural network.

7. The method according to claim 1 wherein the absorbance calculation module is further configured such that the calculation of the colour absorbance image includes a colour background vector;
wherein the colour background vector is updated during the training, according to minimization of the stain deconvolution loss function.

8. The method according to claim 7 wherein the colour background vector is defined according to background parameters of the stain deconvolution network, and wherein the background parameters are initialized prior to the training.

9. The method according to claim 7 wherein the stain deconvolution network comprises a background neural network, the background neural network being configured to determine the colour background vector, and wherein the background neural network is trained according to the stain deconvolution loss function.

10. The method according to claim 9 wherein the background neural network is an encoder-decoder network.

11. The method according to claim 10 wherein values of the colour background vector are determined according to latent features of the background neural network.

12. The method according to claim 1 wherein the stain vectors are updated during the training, according to minimization of the stain deconvolution loss function.

13. The method according to claim 12 wherein the stain vectors are defined according to stain vector parameters stored within the stain deconvolution network, and wherein the stain vector parameters are initialized prior to the training.

14. The method according to claim 12 wherein the stain deconvolution network comprises a plurality of stain vector neural networks, each stain vector neural network being configured to determine a respective stain vector, and wherein each stain vector neural network is trained according to the stain deconvolution loss function.

15. The method according to claim 14 wherein at least one stain vector neural network of the stain deconvolution network is an encoder-decoder network.

16. The method according to claim 15 wherein values of the stain vector corresponding to at least one stain vector neural network are determined according to latent features of the at least one stain vector neural network.

17. The method according to claim 14 wherein, during at least an initial portion of the training, the stain deconvolution loss function comprises an additional loss term based on a difference between the stain vectors calculated by the stain vector neural networks and pre-determined initialization values of the stain vectors.

18. The method according to claim 17 wherein the additional loss term is included in the stain deconvolution loss function during the initial portion of the training and is absent from the stain deconvolution loss function during a subsequent portion of the training.

19. The method according to claim 12 further comprising employing the stain vectors to perform normalization when processing a different colour target image.

20. The method according to claim 1 further comprising employing the colour absorbance image to generate an output image, thereby providing a regenerated version of the colour target image.

21. The method according to claim 1 wherein the first loss component is based on a difference between the colour absorbance image and a target colour absorbance image generated from the colour target image.

22. The method according to claim 1 wherein the first loss component is based on a difference between the colour target image and an output image generated based on the colour absorbance image.

23. The method according to claim 1 wherein at least one input dataset is randomly generated.

24. The method according to claim 1 wherein at least two of the input datasets are a common input dataset.

25. The method according to claim 1 wherein at least one of convolutional auto-encoder neural network includes a skip connection.

26. The method according to claim 1 wherein, during at least an initial portion of the training, computation of the loss function is augmented using at least one transformation of the input datasets.

27. The method according to claim 1 wherein the colour target image is a first colour tile of a main color image, and wherein the stain vectors obtained after training are final stain vectors, the method further comprising employing the final stain vectors when performing stain deconvolution of another colour tile of the main colour image.

28. The method according to claim 27 wherein the final stain vectors are employed to initialize stain vectors when performing stain deconvolution of the other colour tile of the main colour image.

29. The method according to claim 1 further comprising employing the stain concentration maps to perform stain quantification.

30. A system for performing stain deconvolution on a colour target image, the system comprising:
control and processing circuitry comprising at least one processor and memory, said memory comprising instructions executable by said at least one processor for performing operations comprising:
generating a stain deconvolution network comprising:
a plurality of convolutional auto-encoder neural networks, each convolutional auto-encoder neural network being configured to process a respective input dataset to generate a respective output dataset, each input dataset comprising a respective two-dimensional array having dimensions equal to the pixel dimensions of the colour target image;
an absorbance calculation module configured to employ an absorbance model to generate a colour absorbance image, the colour absorbance image being generated by processing a plurality of stain vectors and a plurality of stain concentration maps, wherein each stain vector and each stain concentration map is associated with a respective stain;
the absorbance calculation module being operatively coupled to the plurality of convolutional auto-encoder neural networks, such that each stain concentration map is obtained from the output dataset of a respective convolutional auto-encoder neural network; and
training the stain deconvolution network according to a stain deconvolution loss function comprising:
a first loss component configured to minimize generation loss associated with the colour target image; and
a second loss component configured to facilitate separation between the stain concentration maps;
such that after the training, the stain concentration maps respectively represent deconvoluted stain concentration maps of the stains within the colour target image.
